(19) United States
(12) Patent Application Publication
(10) Pub. No.: US 2009/0061081 A1
(43) Pub. Date: Mar. 5, 2009

(54) PROCESS FOR DEPOSITING A COATING LAYER SYSTEM ONTO A SUBSTRATE

(76) Inventors: William E. Eibon, Elyria, OH (US); Gerald Koenigsmark, Lakewood, OH (US); William E. Michael, Brecksville, OH (US)

Correspondence Address: PPG INDUSTRIES INC;INTELLECTUAL PROPERTY DEPT, ONE PPG PLACE, PITTSBURGH, PA, 15272, US

(21) Appl. No.: 11/846,152

(22) Filed: Aug. 28, 2007

(51) Int. Cl. B05D 1/36; B05D 3/02

(52) U.S. Cl. 427/202; 427/372.2

(57) ABSTRACT

A process for coating a substrate comprising: (a) depositing a primer-surfacer coating composition onto at least a portion of the substrate; (b) curing at least a portion of the primer-surfacer coating composition; (c) depositing a hiding coating composition onto a least a portion of the primer-surfacer coating composition; and (d) depositing a color-imparting non-hiding coating composition onto at least a portion of the hiding coating composition, wherein the second basecoat comprises a nanoparticulate, and wherein a portion of the hiding coating composition is not cured prior to the deposition of the color-imparting non-hiding coating composition; (e) optionally, dehydrating at least a portion of the hiding coating composition and the color-imparting non-hiding coating composition; and (f) curing at least a portion of the first base coat and the second basecoat simultaneously.

### FIELD OF THE INVENTION

The present invention relates to methods of coating a substrate.

### BACKGROUND OF THE INVENTION

When compared to non-photostable dyes, conventional pigment pastes, which are used in a coating (e.g., a basecoat or tinted clear), and which have pigment particles of micron size are unable to achieve the same level of appearance, such as high chroma and transparency, as a coating that utilizes the non-photostable dyes. The inability of conventional pigment pastes to match the non-photostable dyes' appearance is typically due to Mie light scattering.

Accordingly, the addition of nano size pigments can improve a coating's appearance. However, one shortcoming with just adding nano size pigments into a coating is that the color space (color effect) of the coating is typically inferior to the color space that can be obtained with a non-photostable dye. Moreover, another shortcoming with adding nano size pigments to a coating is that the nano tint transparency responsible for a certain color effect does not adequately shield underlying coatings from potentially damaging wavelengths of electromagnetic radiation (i.e., visible light). As a consequence, degradation of certain underlying coating layers can result from use of nano size pigments in a conventional coating. This degradation can lead to delamination within the overall coating system.

Additionally, incorporation of nano scale pigments into a coating layer that is used in a tricoat layer system. For example, a conventional tricoat layer system is applied onto a substrate in the following manner: (i) a first stage color coating is applied over a primed substrate; (ii) after a brief ambient air flash, a second stage color coating is applied wet-on-wet over the first stage color coating; (iii) after a brief air flash or heated dehydration, a conventional or tinted clear is applied wet-on-wet over the second stage color coating. The composite wet topcoat system is then cured simultaneously. One shortcoming associated with such a tricoat layer system is that it suffers from excessive color variation due to film thickness variation within both the basecoat and clearcoat layers.

Therefore, there exists a need for a process of applying a coating layer system onto a substrate that addresses the shortcomings described above.

### SUMMARY OF THE INVENTION

The present invention is directed towards a process for coating a substrate comprising: (a) depositing a primer-surfacer coating composition onto at least a portion of the substrate; (b) curing at least a portion of the primer-surfacer coating composition; (c) depositing a hiding coating composition onto a least a portion of the primer-surfacer coating composition; and (d) depositing a color-imparting non-hiding coating composition onto at least a portion of the hiding coating composition, wherein the second basecoat comprises a nanoparticulate, and wherein a portion of the hiding coating composition is not cured prior to the deposition of the color-imparting non-hiding coating composition; (e) optionally, dehydrating at least a portion of the hiding coating composition and the color-imparting non-hiding coating composition; and (f) curing at least a portion of the first base coat and the second basecoat simultaneously.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Plural encompasses singular and vice versa. For example, although reference is made herein (including the claims) to “a” primer coating composition, “a” color containing coating composition, “a” substantially non-pigmented coating composition, a mixture of any of these can be used.

As employed herein, the term “number” means one or an integer greater than one (i.e., a plurality).

When referring to any numerical range of values, such ranges are understood to include each and every number and/or fraction between the stated range minimum and maximum.

As used herein, the term “polyol” or variations thereof refers broadly to a material having an average of two or more hydroxyl groups per molecule. It will be understood, however, that a “polyol” residue or moiety in a reaction product encompasses a material that may have one or more hydroxyl groups per molecule.

The present invention is directed to a process for coating a substrate with a coating system wherein the coating system achieves an appearance that is substantially similar to and/or exceeds that of a coating system that utilizes a non-photostable dye in a coating layer.

As stated above, the process begins with the application of a primer-surfacer coating composition onto a portion of a substrate using techniques that are known in the art. The type of substrate onto which the primer-surfacer coating composition is applied is not meant to be limiting and, therefore, includes metal substrates, metal alloy substrates, substrates that has been metallized, such as nickel plated plastic, and/or a non-metallic or non-metallized substrate such as a plastic or a plastic composite. In certain embodiments, the metal or metal alloy can be aluminum and/or steel. For example, the steel substrate could be cold rolled steel, electrogalvanized steel, and hot dipped galvanized steel. Moreover, in some embodiments, the substrate may comprise a portion of a vehicle such as a vehicular body (e.g., without limitation, door, body panel, trunk deck lid, roof panel, hood, and/or roof) and/or a vehicular frame. As used herein, “vehicle” or variations thereof includes, but is not limited to, civilian, commercial, and military land vehicles such as cars and trucks. It will also be understood that, in some embodiments, the substrate may be pretreated with a pretreatment solution, such as a zinc phosphate solution as described in U.S. Pat. Nos. 4,793,867 and 5,588,989, which are incorporated herein by reference, or not pretreated with a pretreatment solution.

In certain embodiments, the primer-surfacer coating composition is applied onto a substrate that has been at least partially coated with an electrodepositable coating composition such as those described in U.S. patent application Ser. No. 11/835,600, which is incorporated herein by reference. For clarity, when referring to a “substrate” herein, it should be noted that the substrate may or may not be pretreated and/or may or may not have an electrodepositable coating.

The primer-surfacer serves to enhance chip resistance of subsequently applied top coatings as well as to ensure good appearance of the top coatings. As will be discussed in greater detail below, the additional coating layers (e.g., a hiding coating composition, a color-imparting non-hiding coating composition, and a topcoat coating composition) are then applied to the cured primer-surfacer coating. As used herein and in the claims, “primer-surfacer” refers to a primer composition for use under a subsequently applied topcoating composition, and includes such materials as thermoplastic and/or crosslinking (e.g., thermosetting) film-forming resins generally known in the art of organic coating compositions. Suitable primers and primer-surfacer coating compositions include spray applied primers, as are known to those skilled in the art. Examples of suitable primers include several available from PPG Industries, Inc., Pittsburgh, Pa., as DPX-1791, DPX-1804, DSPX-1537, GPXH-5379, OPP-2645, PCV-70118, and 1177-225A.

As is described in U.S. Pat. No. 5,356,973 to Taljan et al., the spray applied primer-surfacer can be applied to the electrodepositable coating layer before applying a base coat and/or topcoating over the primer-surfacer coating composition. For example, substrates, such as panels, can be electrocoated with ED-11 electrodepositable coating from PPG Industries Inc. and can be primed with a commercially available PPG Industries primer-surfacer coating composition coded E 730G305. This primer-surfacer coating composition can be cured for 25 minutes at 165° C. (329° F.). Another example of a suitable primer-surfacer coating composition that can be utilized in the present invention is the two-package, acrylic urethane primer surfacer known as K200/K201, which is more fully disclosed in U.S. Pat. Nos. 5,239,012 and 5,182,355. The resulting primer-surfacer coating may be sanded with No. 400 grit paper and sealed with DP-40/401, which is a two-component epoxy primer which was reduced 100 percent by volume with a thinner, DTU 800. The K200/K201, DP-40/401, and DTU 800 are all available from PPG Industries, Inc.

An additional primer-surfacer coating composition that may be utilized in the present invention is that available from PPG Industries, Inc. as E-5584. It is reducible with 2-butoxyethylacetate to a viscosity of 23 seconds as measured with a No. 4 Ford cup. This primer-surfacer coating composition can be sprayed automatically and cured by flashing at ambient conditions for 15 minutes followed by heating for around 30 minutes at around 165° C. (325° F.) to produce a coating that can have dry film thickness of around 30 microns. The cured coating may be sanded smooth with 500 grit sandpaper. Useful automatic spraying for both the primer-surfacer coating composition is the SPRAYMATION 310160 Automatic Test Panel Spray Unit available from SPRAYMATION Inc. The useable spray gun is a Binks Model 610, with open gun pressure 60 psi (4.22 kg/cm.sup.2) and traverse speed of around 80 rpm.

Another suitable primer-surfacer coating composition that can be utilized in the present invention includes a water dispersed primer-surfacer composition as disclosed in U.S. Pat. No. 4,303,581, which is herein incorporated by reference. This particular primer-surfacer coating composition has (a) 50 to 90 percent of a high molecular addition copolymer of a styrenic monomer with acrylic monomers in latex form, (b) about 5 to 40 percent of a water soluble epoxy ester resin, and (c) about 5 to 20 percent of at least one water soluble or water dispersible aminoplast resin. All percents are based on percent by weight of the total of the binder ingredients.

Another suitable primer-surfacer coating composition that can be utilized in the present invention is the primer-surfacer described in U.S. patent application Ser. No. 11/773,482, which is incorporated herein by reference.

After the primer-surfacer coating composition has been applied onto the substrate, at least a portion of the primer-surfacer coating composition is cured using techniques that are known in the art. In some embodiments, the primer-surfacer is cured at temperatures ranging from 140° C. to 165° C. for a time ranging from 15 to 30 minutes.

Applied onto at least a portion of the cured primer-surfacer coating composition is a hiding coating composition. It will be understood that the layer which results from the hiding coating composition is substantially opaque thereby substantially shielding the underlying electrocoating from electromagnetic radiation which may causes delamination of the coating system. As used herein, “opaque” means ≦0.5% energy transmission in the wavelengths of the visible light spectrum ranging from 380 nm to 500 nm and less than 0.1% energy transmission from 290 to 380 nm. It should be noted that the above opacity is achieved at a process film thickness ranging from 4 μm-35 μm. Moreover, it will be understood that in order to achieve the desired opacity, the film thickness of the coating layer will be dependent upon the color of the hiding coating composition. The opaque nature of the hiding coating layer is derived from using a combination of light stabilizers (e.g., hindered amine light stabilizers), UV light absorbers, and/or pigment types in amounts sufficient to restrict light energy transmission to the desired level.

In certain embodiments, the hiding coating composition comprises a nanoparticulate (nanoparticle). As used herein, a “nanoparticulate” means a nanopigment (nano scale pigment) or a color inducing substance that has an average particle size of ≦100 nanometers. As used herein, a “nanopigment” and a “color inducing substance” means a pigment or substance that substantially absorbs and/or interacts with some wavelengths of visible light (i.e., wavelengths ranging from 400 to 700 nm). It should be noted that as used herein, “nanoparticulate” does not refer to a microgel particle. Nanoparticles suitable for use in the present invention can include any of the nano sized inorganic, organic, or inorganic/organic hybrid materials known in the art.

In embodiments where the average particle size of the particles is greater than 0.05 micron (that is, greater than 50 nanometers), the average particle size can be measured according to known laser scattering techniques. For example the average particle size of such particles is measured using a Horiba Model LA 900 laser diffraction particle size instrument, which uses a helium-neon laser with a wave length of 633 nm to measure the size of the particles and assumes the particle has a spherical shape (i.e., the “particle size” refers to the smallest sphere that will completely enclose the particle).

In embodiments where the size of the particles is less than or equal to one micron (that is, less than 1000 nanometers), the average particle size can be determined by visually examining an electron micrograph of a transmission electron microscopy (“TEM”) image, measuring the diameter of the particles in the image, and calculating the average particle size based on the magnification of the TEM image. One of ordinary skill in the art will understand how to prepare such a TEM image, and a description of one such method is disclosed in the examples set forth below. In one non-limiting embodiment of the present invention, a TEM image with 105,000× magnification is produced, and a conversion factor is obtained by dividing the magnification by 1000. Upon visual inspection, the diameter of the particles is measured in millimeters, and the measurement is converted to nanometers using the conversion factor. The diameter of the particle refers to the smallest diameter sphere that will completely enclose the particle.

The shape (or morphology) of the particles can vary depending upon the specific embodiment of the present invention and its intended application. For example, generally spherical morphologies (such as solid beads, microbeads, or hollow spheres), can be used, as well as particles that are cubic, platy, lamellar or acicular (elongated or fibrous). Additionally, the particles can have an internal structure that is hollow, porous or void free, or a combination of any of the foregoing (e.g., a hollow center with porous or solid walls). For more information on suitable particle characteristics see H. Katz et al. (Ed.), Handbook of Fillers and Plastics (1987) at pages 9-10, which are specifically incorporated by reference herein.

Depending on the desired properties and characteristics of the resultant dispersion and/or coating compositions containing the dispersions of the present invention (e.g., coating hardness, scratch resistance, stability, or color), it will be recognized by one skilled in the art that mixtures of one or more particles having different average particle sizes can be employed in the process of the present invention.

The nanoparticles can be formed from materials selected from polymeric and nonpolymeric inorganic materials, polymeric and nonpolymeric organic materials, composite materials, and mixtures of any of the foregoing. As used herein, “formed from” denotes open (e.g., “comprising”) claim language. As such, it is intended that a composition “formed from” a list of recited components be a composition comprising at least these recited components, and can further comprise other, non-recited components, during the composition's formation. Additionally, as used herein, the term “polymer” is meant to encompass oligomers, and includes without limitation both homopolymers and copolymers.

As used herein, the term “polymeric inorganic material” means a polymeric material having a backbone repeat unit based on an element or elements other than carbon. For more information see James Mark et al., Inorganic Polymers, Prentice Hall Polymer Science and Engineering Series, (1992) at page 5, which is incorporated herein by reference. Moreover, as used herein, the term “polymeric organic materials” means synthetic polymeric materials, semi-synthetic polymeric materials and natural polymeric materials, all of which have a backbone repeat unit based on carbon.

An “organic material,” as used herein, means carbon containing compounds wherein the carbon is typically bonded to itself and to hydrogen, and often to other elements as well, and excludes binary compounds such as the carbon oxides, the carbides, carbon disulfide, etc.; such ternary compounds as the metallic cyanides, metallic carbonyls, phosgene, carbonyl sulfide, etc.; and carbon-containing ionic compounds such as metallic carbonates, for example calcium carbonate and sodium carbonate. See R. Lewis, Sr., Hawley's Condensed Chemical Dictionary, (12th Ed. 1993) at pages 761-762, and M. Silberberg, Chemistry The Molecular Nature of Matter and Change (1996) at page 586, which are specifically incorporated by reference herein.

As used herein, the term “inorganic material” means any material that is not an organic material.

As used herein, the term “composite material” means a combination of two or more differing materials. More specifically, the surface of the particle can be modified in any manner well known in the art, including, but not limited to, chemically or physically changing its surface characteristics using techniques known in the art.

For example, in some embodiments, a particle can be formed from a primary material that is coated, clad or encapsulated with one or more secondary materials to form a composite particle. In other embodiments, particles formed from composite materials can be formed from a primary material that is coated, clad or encapsulated with a different form of the primary material. For more information on particles useful in the present invention, see G. Wypych, Handbook of Fillers, 2nd Ed. (1999) at pages 15-202, which are specifically incorporated by reference herein.

As aforementioned, the nanoparticles useful in the processes of the present invention can include any nano sized inorganic materials known in the art. Suitable particles can be formed from ceramic materials, metallic materials, and mixtures of any of the foregoing. Non-limiting examples of such ceramic materials can comprise metal oxides, mixed metal oxides, metal nitrides, metal carbides, metal sulfides, metal silicates, metal borides, metal carbonates, and mixtures of any of the foregoing. Specific, nonlimiting examples of metal nitrides are, for example, boron nitride; specific, nonlimiting examples of metal oxides are, for example zinc oxide; nonllmiting examples of suitable mixed metal oxides include aluminum silicates and magnesium silicates; nonlimiting examples of suitable metal sulfides are, for example molybdenum disulfide, tantalum disulfide, tungsten disulfide, and zinc sulfide; nonlimiting suitable examples of metal silicates are, for example aluminum silicates and magnesium silicates such as vermiculite.

In certain embodiments of the present invention the nanoparticles comprise inorganic nanoparticles selected from aluminum, barium, bismuth, boron, cadmium, calcium, cerium, cobalt, copper, iron, lanthanum, magnesium, manganese, molybdenum, nitrogen, oxygen, phosphorus, selenium, silicon, silver, sulfur, tin, titanium, tungsten, vanadium, yttrium, zinc, and zirconium, including, where applicable, oxides thereof, nitrides thereof, phosphides thereof, phosphates thereof, selenides thereof, sulfides thereof, sulfates thereof, and mixtures thereof. Suitable non-limiting examples of the foregoing inorganic microparticles can include alumina, silica, titania, ceria, zirconia, bismuth oxide, magnesium oxide, iron oxide, aluminum silicate, boron carbide, nitrogen doped titania, and cadmium selenide.

In some embodiments, the nanoparticles can comprise a core of essentially a single inorganic oxide such as silica in colloidal, fumed, or amorphous form, alumina or colloidal alumina, titanium dioxide, iron oxide, cesium oxide, yttrium oxide, colloidal yttria, zirconia (e.g., colloidal or amorphous zirconia), and mixtures of any of the foregoing; or an inorganic oxide of one type upon which is deposited on organic oxide of another type.

Nonpolymeric, inorganic materials useful in forming the nanoparticles of the present invention can comprise inorganic materials selected from graphite, metals, oxides, carbides, nitrides, borides, sulfides, silicates, carbonates, sulfates, and hydroxides. A nonlimiting example of a useful inorganic oxide is zinc oxide. Nonlimiting examples of suitable inorganic sulfides include molybdenum disulfide, tantalum disulfide, tungsten disulfide, and zinc sulfide. Nonlimiting examples of useful inorganic silicates include aluminum silicates and magnesium silicates, such as vermiculite. Nonlimiting examples of suitable metals include molybdenum, platinum, palladium, nickel, aluminum, copper, gold, iron, silver, alloys, and mixtures of any of the foregoing.

In some embodiments of the present invention, the nanoparticles can be selected from fumed silica, amorphous silica, colloidal silica, alumina, colloidal alumina, titanium dioxide, iron oxide, cesium oxide, yttrium oxide, colloidal yttria, zirconia, colloidal zirconia, and mixtures of any of the foregoing. In other embodiments of the present invention, the nanoparticles comprise colloidal silica. As disclosed above, these materials can be surface treated or untreated. Other useful nanoparticles include surface-modified silicas such as are described in U.S. Pat. No. 5,853,809 at column 6, line 51 to column 8, line 43, which is incorporated herein by reference.

As another alternative, a nanoparticle can be formed from a primary material that is coated, clad or encapsulated with one or more secondary materials to form a composite material. Alternatively, a nanoparticle can be formed from a primary material that is coated, clad or encapsulated with a differing form of the primary material to form a composite material.

The nanoparticles can be formed from nonpolymeric, organic materials. Nonlimiting examples of nonpolymeric, organic materials useful in the present invention include, but are not limited to, stearates (such as zinc stearate and aluminum stearate), diamond, carbon black and stearamide. In an embodiment of the present invention, the nanoparticulates comprise carbon black.

The nanoparticles can be formed from inorganic polymeric materials. Nonlimiting examples of useful inorganic polymeric materials include polyphosphazenes, polysilanes, polysiloxanes, polygermanes, polymeric sulfur, polymeric selenium, silicones and mixtures of any of the foregoing. A specific, nonlimiting example of a particle formed from an inorganic polymeric material suitable for use in the present invention is Tospearl¹, which is a particle formed from cross-linked siloxanes and is commercially available from Toshiba Silicones Company, Ltd. of Japan. 1 See R. J. Perry “Applications for Cross-Linked Siloxane Particles” Chemtech, February 1999 at pages 39-44.

The nanoparticles can be formed from synthetic, organic polymeric materials. Nonlimiting examples of suitable organic polymeric materials include, but are not limited to, thermoset materials and thermoplastic materials as discussed herein. Nonlimiting examples of suitable thermoplastic materials include thermoplastic polyesters such as polyethylene terephthalate, polybutylene terephthalate and polyethylene naphthalate, polycarbonates, polyolefins such as polyethylene, polypropylene and polyisobutene, acrylic polymers such as copolymers of styrene and an acrylic acid monomer and polymers containing methacrylate, polyamides, thermoplastic polyurethanes, vinyl polymers, and mixtures of any of the foregoing.

Nonlimiting examples of suitable thermoset materials include thermoset polyesters, vinyl esters, epoxy materials, phenolics, aminoplasts, thermoset polyurethanes and mixtures of any of the foregoing. A specific, nonlimiting example of a synthetic polymeric particle formed from an epoxy material is an epoxy microgel particle.

The nanoparticles can also be hollow particles formed from materials selected from polymeric and nonpolymeric inorganic materials, polymeric and nonpolymeric organic materials, composite materials, or combinations thereof. Nonlimiting examples of suitable materials from which the hollow particles can be formed are described above.

Organic materials useful in the practice of the present invention can include organic pigments, for example, azo (monoazo, disazo, β-Naphthol, Naphthol AS salt type azo pigment lakes), benzimidazolone, disazo condensation, isoindolinone, isoindoline), and polycyclic (phthalocyanine, quinacridone, perylene, perinone, diketopyrrolo pyrrole, thioindigo, anthraquinone (indanthrone, anthrapyrimidine, flavanthrone, pyranthrone, anthanthrone, dioxazine, triarylcarbonium, quinophthalone) pigments, and mixtures of any of the foregoing. In one embodiment of the present invention, the organic material is selected from perylenes, quinacridones, phthalocyanines, isoindolines, dioxazines (that is, triphenedioxazines), 1,4-diketopyrrolopyrroles, anthrapyrimidines, anthanthrones, flavanthrones, indanthrones, perinones, pyranthrones, thioindigos, 4,4′-diamino-1,1′-dianthraquinonyl, as well as substituted derivatives thereof, and mixtures thereof.

Perylene pigments used in the practice of the present invention may be unsubstituted or substituted. Substituted perylenes may be substituted at imide nitrogen atoms for example, and substituents may include an alkyl group of 1 to 10 carbon atoms, an alkoxy group of 1 to 10 carbon atoms and a halogen (such as chlorine) or combinations thereof. Substituted perylenes may contain more than one of any one substituent. The diimides and dianhydrides of perylene-3,4,9,10-tetracarboxylic acid are preferred. Crude perylenes can be prepared by methods known in the art. Please review, W. Herbst and K. Hunger, Industrial Organic Pigments (New York: VCH Publishers, Inc., 1993), pages 9 and 467-475, H. Zollinger, Color Chemistry (VCH Verlagsgessellschaft, 1991), pages 227-228 and 297-298, and M. A. Perkins, “Pyridines and Pyridones” in The Chemistry of Synthetic Dyes and Pigments, ed. H. A. Lubs (Malabar, Fla.: Robert E. Krieger Publishing Company, 1955), pages 481-482, incorporated herein by reference.

Phthalocyanine pigments, especially metal phthalocyanines may be used in the practice of the present invention. Although copper phthalocyanines are more readily available, other metal-containing phthalocyanine pigments, such as those based on zinc, cobalt, iron, nickel, and other such metals, may also be used. Metal-free phthalocyanines are also suitable. Phthalocyanine pigments may be unsubstituted or partially substituted, for example, with one or more alkyl (having 1 to 10 carbon atoms), alkoxy (having 1 to 10 carbon atoms), halogens such as chlorine, or other substituents typical of phthalocyanine pigments. Phthalocyanines may be prepared by any of several methods known in the art. They are typically prepared by a reaction of phthalic anhydride, phthalonitrile, or derivatives thereof, with a metal donor, a nitrogen donor (such as urea or the phthalonitrile itself), and an optional catalyst, preferably in an organic solvent. See, for example, W. Herbst and K. Hunger, Industrial Organic Pigments (New York: VCH Publishers, Inc., 1993), pages 418-427, H. Zollinger, Color Chemistry (VCH Verlagsgessellschaft, 1991), pages 101-104, and N. M. Bigelow and M. A. Perkins, “Phthalocyanine Pigments” in The Chemistry of Synthetic Dyes and Pigments, ed. H. A. Lubs (Malabar, Fla.: Robert E. Krieger Publishing Company, 1955), pages 584-587; see also U.S. Pat. Nos. 4,158,572, 4,257,951, and 5,175,282 and British Patent 1,502,884, incorporated herein by reference.

Quinacridone pigments, as used herein, include unsubstituted or substituted quinacridones (for example, with one or more alkyl, alkoxy, halogens such as chlorine, or other substituents typical of quinacridone pigments), and are suitable for the practice of the present invention. The quinacridone pigments may be prepared by any of several methods known in the art but are preferably prepared by thermally ring-closing various 2,5-dianilinoterephthalic acid precursors in the presence of polyphosphoric acid. E.g., S. S. Labana and L. L. Labana, “Quinacridones” in Chemical Review, 67, 1-18 (1967), and U.S. Pat. Nos. 3,157,659, 3,256,285, 3,257,405, and 3,317,539.

Isoindoline pigments, which can optionally be substituted symmetrically or unsymmetrically, are also suitable for the practice of the present invention can be prepared by methods known in the art. E.g., W. Herbst and K. Hunger, Industrial Organic Pigments (New York: VCH Publishers, Inc., 1993), pages 398-415. A particularly preferred isoindoline pigment, Pigment Yellow 139, is a symmetrical adduct of iminoisoindoline and barbituric acid precursors. Dioxazine pigments (that is, triphenedioxazines) are also suitable organic pigments and can be prepared by methods known in the art. See for example, W. Herbst and K. Hunger, Industrial Organic Pigments (New York: VCH Publishers, Inc., 1993), pages 534-537.

Mixtures of any of the previously described inorganic nanoparticulates and/or organic nanoparticulates can also be used.

Moreover, it is noted that the exact choice of nanoparticulates will depend upon the specific application and the color performance requirements of a coating layer.

The nanoparticulates can be formed by any of a number of various methods known in the art. In one embodiment, the nanoparticulates can be prepared by pulverizing and classifying the dry particulate material. For example, bulk pigments such as any of the inorganic or organic pigments discussed above, can be milled with milling media having a particle size of less than or equal to 0.5 millimeters (mm), or less than 0.3 mm, or less than 0.1 mm. The pigment particles typically are milled to nanoparticulate sizes in a high energy mill in one or more solvents (either water, organic solvent, or a mixture of the two), optionally in the presence of a polymeric grind vehicle and/or a dispersant. Other suitable methods for producing the nanoparticulates include crystallization, precipitation, gas phase condensation, and chemical attrition (i.e., partial dissolution). It should be noted that any known method for producing the nanoparticulates can be employed, provided that reagglomeration of the nanoparticles is minimized or avoided altogether.

In some embodiments, nanoparticles are formed as described above, and then dispersed or encapsulated in a polymeric binder or matrix to obtain a larger nano or micron scale particle that contains one or more nano pigments. The resulting particle is stabilized.

In some embodiments, the nanoparticles that may be utilized in the present invention include those described in WO 2005/000914 (paragraphs [00012]-[000237]), U.S. Pat. Pub. Nos. 2006/0251896A1 (paragraphs [0008]-[0148]), 2006/0246305 (paragraphs [0006]-[0110]), 2007/0149654 (paragraphs [0006]-[0110]), all of which are incorporated herein by reference.

In certain embodiments, the hiding coating composition may contain a mixture of both nanoparticles and conventional pigments to obtain the desired color. For example, the hiding coating composition of the present invention can further comprise one or more pigments (e.g., a metallic and/or an effect pigment). Nonlimiting examples of suitable metallic pigments include aluminum, copper, bronze and metal oxide coated flakes. Besides the metallic pigments, the hiding coating composition also can contain nonmetallic color pigments conventionally used in surface coatings such as, for example, inorganic pigments such as titanium dioxide, iron oxide, chromium oxide, and carbon black; and organic pigments such as phthalocyanine blue and phthalocyanine green. Filler pigments such as clay, talc and calcium carbonate also can be included.

The hiding coating composition of the present invention also can comprise optional ingredients such as those well known in the art of formulating surface coatings. Such optional ingredients can comprise, for example, surface active agents, flow control agents, thixotropic agents, fillers, anti-gassing agents, organic co-solvents, catalysts, and other customary auxiliaries. Nonlimiting examples of these materials and suitable amounts are described in U.S. Pat. Nos. 4,220,679; 4,403,003; 4,147,769; and 5,071,904, which patents are incorporated herein by reference.

As would be understood by one skilled in the art, coating film thickness and curing temperatures and conditions will depend upon the type of coating layer to be formed (i.e., a primer coating, a basecoating, a monocoat); as well as the coating composition itself (i.e., whether thermosetting or thermoplastic, whether ambient or thermally curable, and, if thermosetting, the type of curing reaction required).

In some embodiments, the hiding coating composition further comprises an acrylic polymer, a polyester polymer, a polyurethane polymer, a polyether polymer, a polyepoxide polymer, a silicon-containing polymer, or combinations thereof. Moreover, the polymer in the hiding coating composition has a number of reactive functional groups that can react with a crosslinking agent that is typically incorporated within the hiding coating composition. For example, the reactive functional groups include, without limitation, a hydroxyl group, a carboxyl group, an isocyanate group, a blocked isocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, an epoxy group, or combinations thereof.

Suitable hydroxyl group and/or carboxyl group-containing acrylic polymers can be prepared from polymerizable ethylenically unsaturated monomers and are typically copolymers of (meth)acrylic acid and/or hydroxylalkyl esters of (meth)acrylic acid with one or more other polymerizable ethylenically unsaturated monomers such as alkyl esters of (meth)acrylic acid including methyl (meth)acrylate, ethyl (meth)acrylate, butyl (meth)acrylate and 2-ethyl hexylacrylate, and vinyl aromatic compounds such as styrene, alpha-methyl styrene, and vinyl toluene. As used herein, “(meth)acrylate” and like terms is intended to include both acrylates and methacrylates.

In some embodiments of the present invention, the acrylic polymer can be prepared from ethylenically unsaturated, beta-hydroxy ester functional monomers. Such monomers can be derived from the reaction of an ethylenically unsaturated acid functional monomer, such as monocarboxylic acids, for example, acrylic acid, and an epoxy compound which does not participate in the free radical initiated polymerization with the unsaturated acid monomer. Examples of such epoxy compounds include glycidyl ethers and esters. Suitable glycidyl ethers include glycidyl ethers of alcohols and phenols such as butyl glycidyl ether, octyl glycidyl ether, phenyl glycidyl ether and the like. Suitable glycidyl esters include those which are commercially available from Shell Chemical Company under the tradename CARDURA E; and from Exxon Chemical Company under the tradename GLYDEXX-10. Alternatively, the beta-hydroxy ester functional monomers can be prepared from an ethylenically unsaturated, epoxy functional monomer, for example glycidyl (meth)acrylate and allyl glycidyl ether, and a saturated carboxylic acid, such as a saturated monocarboxylic acid, for example isostearic acid.

Epoxy functional groups can be incorporated into the polymer prepared from polymerizable ethylenically unsaturated monomers by copolymerizing oxirane group-containing monomers, for example glycidyl (meth)acrylate and allyl glycidyl ether, with other polymerizable ethylenically unsaturated monomers, such as those discussed above. Preparation of such epoxy functional acrylic polymers is described in detail in U.S. Pat. No. 4,001,156 at columns 3 to 6, incorporated herein by reference.

Carbamate functional groups can be incorporated into the polymer prepared from polymerizable ethylenically unsaturated monomers by copolymerizing, for example, the above-described ethylenically unsaturated monomers with a carbamate functional vinyl monomer such as a carbamate functional alkyl ester of methacrylic acid. Useful carbamate functional alkyl esters can be prepared by reacting, for example, a hydroxyalkyl carbamate, such as the reaction product of ammonia and ethylene carbonate or propylene carbonate, with methacrylic anhydride. Other useful carbamate functional vinyl monomers include, for instance, the reaction product of hydroxyethyl methacrylate, isophorone diisocyanate, and hydroxypropyl carbamate; or the reaction product of hydroxypropyl methacrylate, isophorone diisocyanate, and methanol. Still other carbamate functional vinyl monomers may be used, such as the reaction product of isocyanic acid (HNCO) with a hydroxyl functional acrylic or methacrylic monomer such as hydroxyethyl acrylate, and those described in U.S. Pat. No. 3,479,328, incorporated herein by reference. Carbamate functional groups can also be incorporated into the acrylic polymer by reacting a hydroxyl functional acrylic polymer with a low molecular weight alkyl carbamate such as methyl carbamate. Pendant carbamate groups can also be incorporated into the acrylic polymer by a “transcarbamoylation” reaction in which a hydroxyl functional acrylic polymer is reacted with a low molecular weight carbamate derived from an alcohol or a glycol ether. The carbamate groups exchange with the hydroxyl groups yielding the carbamate functional acrylic polymer and the original alcohol or glycol ether. Also, hydroxyl functional acrylic polymers can be reacted with isocyanic acid to provide pendent carbamate groups. Likewise, hydroxyl functional acrylic polymers can be reacted with urea to provide pendent carbamate groups.

The polymers prepared from polymerizable ethylenically unsaturated monomers can be prepared by solution polymerization techniques, which are well-known to those skilled in the art, in the presence of suitable catalysts such as organic peroxides or azo compounds, for example, benzoyl peroxide or N,N-azobis(isobutylronitrile). The polymerization can be carried out in an organic solution in which the monomers are soluble by techniques conventional in the art. Alternatively, these polymers can be prepared by aqueous emulsion or dispersion polymerization techniques which are well-known in the art. The ratio of reactants and reaction conditions are selected to result in an acrylic polymer with the desired pendent functionality.

In some embodiments, a polyester polymer can be prepared via a condensation reaction of an acid, such as a diacid, and a polyol using techniques that are known in the art. Suitable acids which can be used to prepare the polyester polymer include, but are not limited to, isophthalic acid, terephthalic acid, e-caprolactone, 1,4-Cyclohexanediacid, PRIPOL, dimerized fatty acids, maleic anhydride, hexahydrophthalic anhydride, methylhexahydrophthalic anhydride, tetrahydrophthalic anhydride, phthalic anhydride, adipic acid, azelaic acid, or combinations thereof. Suitable polyols which can be used to prepare the polyester polymer include, but are not limited to, 1,6-hexanediol, butylethylpropanediol, 1,4-cyclohexanedimethanol, 2-methyl-1,3-propanediol, polytetramethylene ether glycols and its oligomers, polytetrahydrofuran and its oligomers, dipropylene glycol, neopentyl glycol, neopentyl glycol hydroxy pivalate, trimethylol propane, butane diol, tripropylene glycol, or combinations thereof.

In certain embodiments, hydroxyl group-containing polyesters can be prepared by reacting an anhydride of a dicarboxylic acid such as hexahydrophthalic anhydride with a diol such as neopentyl glycol in a 1:2 molar ratio. Where it is desired to enhance air-drying, suitable drying oil fatty acids may be used and include those derived from linseed oil, soya bean oil, tall oil, dehydrated castor oil, or tung oil.

In certain embodiments, the hiding coating composition comprises a polyester polymer which is a reaction product of neopentyl glycol, neopentyl glycol hydroxy pivalate, trimethylol propane, adipic acid, ε-caprolactone, and isophthalic acid.

Carbamate functional polyesters can be prepared by first forming a hydroxyalkyl carbamate that can be reacted with the polyacids and polyols used in forming the polyester. Alternatively, terminal carbamate functional groups can be incorporated into the polyester by reacting isocyanic acid with a hydroxy functional polyester. Also, carbamate functionality can be incorporated into the polyester by reacting a hydroxyl polyester with a urea. Additionally, carbamate groups can be incorporated into the polyester by a transcarbamoylation reaction. Preparation of suitable carbamate functional group-containing polyesters is described in U.S. Pat. No. 5,593,733 at column 2, line 40 to column 4, line 9, incorporated herein by reference.

In some embodiments, the polymer can comprise ≧5% of the total resin solids of the hiding coating composition. In other embodiments, the polymer can comprise ≦80% of the total resin solids of the hiding coating composition. In certain embodiments, the total amount of the polymer can range between any combination of values, which were recited in the preceding sentences, inclusive of the recited values. For example, in some embodiments the polymer can comprise 30%-50% of the total resin solids of the hiding coating composition.

As stated above, the polymer in the hiding coating composition comprises a number of functional groups that can react with a curing agent (crosslinking agent) that is incorporated within the hiding coating composition. Dependent upon the reactive functional groups of the polymer in the hiding coating composition, the curing agent can be selected from an aminoplast resin, an isocyanate, a polyepoxide, a polyacid, an anhydride, an amine, a polyol, or combinations thereof.

Aminoplast, which can comprise phenoplasts, can be utilized as curing agents for hydroxyl, carboxylic acid, and carbamate functional group-containing materials are well known in the art. Suitable aminoplast resins, such as, for example, those discussed above, are known to those of ordinary skill in the art. Aminoplasts can be obtained from the condensation reaction of formaldehyde with an amine or amide. Nonlimiting examples of amines or amides include melamine, urea, or benzoguanamine. Condensates with other amines or amides can be used; for example, aldehyde condensates of glycoluril, which give a high melting crystalline product useful in powder coatings. While the aldehyde used is most often formaldehyde, other aldehydes such as acetaldehyde, crotonaldehyde, and benzaldehyde can be used.

The aminoplast typically contains imino and methylol groups and in certain instances at least a portion of the methylol groups are etherified with an alcohol to modify the cure response. Any monohydric alcohol can be employed for this purpose including methanol, ethanol, n-butyl alcohol, isobutanol, and hexanol.

Nonlimiting examples of aminoplasts include melamine-, urea-, or benzoguanamine-formaldehyde condensates, in certain instances monomeric and at least partially etherified with one or more alcohols containing from one to four carbon atoms. Nonlimiting examples of suitable aminoplast resins are commercially available, for example, from Cytec Industries, Inc. under the trademark CYMEL and from Solutia, Inc. under the trademark RESIMENE.

As stated above, the curing agent can also comprise an isocyanate. As used herein, “isocyanates” also includes polyisocyanates and vice versa. The polyisocyanate curing agent may be a fully blocked polyisocyanate with substantially no free isocyanate groups, or it may be partially blocked and reacted with the resin backbone as described in U.S. Pat. No. 3,984,299. The polyisocyanate can be an aliphatic, an aromatic polyisocyanate, or combinations thereof. In some embodiments, diisocyanates are utilized, although in other embodiments higher polyisocyanates can be used in place of or in combination with diisocyanates.

Any suitable alcohol or polyol can be used as a blocking agent for the polyisocyanate in the electrodepositable coating composition of the present invention provided that the agent will deblock at the curing temperature and provided a gelled product is not formed. For example, suitable alcohols include, without limitation, methanol, ethanol, propanol, isopropyl alcohol, butanol, 2-ethylhexanol, butoxyethanol, hexyloxyethanol, 2-ethylhexyloxyethanol, n-butanol, cyclohexanol phenyl carbinol, methylphenyl carbinol, ethylene glycol monobutyl ether, diethylene glycol monobutylether, ethylene glycol monomethylether, propylene glycol monomethylether, or combinations thereof.

In certain embodiments of the present invention, the blocking agent comprises one or more 1,3-glycols and/or 1,2-glycols. In one embodiment of the present invention, the blocking agent comprises one or more 1,2-glycols, typically one or more C₃ to C₆ 1,2-glycols. For example, the blocking agent can be selected from at least one of 1,2-propanediol, 1,3-butanediol, 1,2-butanediol, 1,2-pentanediol, timethylpentene diol, and/or 1,2-hexanediol.

As stated above, the curing agent can comprise an anhydride, which is typically used as curing agents for hydroxy functional group containing materials. Nonlimiting examples of anhydrides suitable for use as curing agents in the compositions of the invention include those having at least two carboxylic acid anhydride groups per molecule which are derived from a mixture of monomers comprising an ethylenically unsaturated carboxylic acid anhydride and at least one vinyl co-monomer, for example, styrene, alpha-methyl styrene, vinyl toluene, and the like. Nonlimiting examples of suitable ethylenically unsaturated carboxylic acid anhydrides include maleic anhydride, citraconic anhydride, and itaconic anhydride. Alternatively, the anhydride can be an anhydride adduct of a diene polymer such as maleinized polybutadiene or a maleinized copolymer of butadiene, for example, a butadiene/styrene copolymer. These and other suitable anhydride curing agents are described in U.S. Pat. No. 4,798,746 at column 10, lines 16-50; and in U.S. Pat. No. 4,732,790 at column 3, lines 41-57, both of which are incorporated herein by reference.

Polyepoxides can be utilized as curing agents for carboxylic acid functional group-containing materials are well known in the art. Nonlimiting examples of polyepoxides suitable for use in the compositions of the present invention comprise polyglycidyl esters (such as acrylics from glycidyl methacrylate), polyglycidyl ethers of polyhydric phenols and of aliphatic alcohols, which can be prepared by etherification of the polyhydric phenol, or aliphatic alcohol with an epihalohydrin such as epichlorohydrin in the presence of alkali. These and other suitable polyepoxides are described in U.S. Pat. No. 4,681,811 at column 5, lines 33 to 58, which is incorporated herein by reference.

Suitable curing agents for epoxy functional group-containing materials comprise polyacid curing agents, such as the acid group-containing acrylic polymers prepared from an ethylenically unsaturated monomer containing at least one carboxylic acid group and at least one ethylenically unsaturated monomer which is free from carboxylic acid groups. Such acid functional acrylic polymers can have an acid number ranging from 30 to 150. Acid functional group-containing polyesters can be used as well. The above-described polyacid curing agents are described in further detail in U.S. Pat. No. 4,681,811 at column 6, line 45 to column 9, line 54, which is incorporated herein by reference.

Also well known in the art as curing agents for isocyanate functional group-containing materials are polyols. Nonlimiting examples of such materials suitable for use in the compositions of the invention include polyalkylene ether polyols, including thio ethers; polyester polyols, including polyhydroxy polyesteramides; and hydroxyl-containing polycaprolactones and hydroxy-containing acrylic copolymers. Also useful are polyether polyols formed from the oxyalkylation of various polyols, for example, glycols such as ethylene glycol, 1,6-hexanediol, Bisphenol A and the like, or higher polyols such as trimethylolpropane, pentaerythritol, and the like. Polyester polyols also can be used. These and other suitable polyol curing agents are described in U.S. Pat. No. 4,046,729 at column 7, line 52 to column 8, line 9; column 8, line 29 to column 9, line 66; and U.S. Pat. No. 3,919,315 at column 2, line 64 to column 3, line 33, both of which are incorporated herein by reference.

Polyamines also can be used as curing agents for isocyanate functional group-containing materials. Nonlimiting examples of suitable polyamine curing agents include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include 1,2-ethylene diamine, 1,2-porphylene diamine, 1,8-octane diamine, isophorone diamine, propane-2,2-cyclohexyl amine, and the like. Nonlimiting examples of suitable aromatic diamines include phenylene diamines and the toluene diamines, for example, o-phenylene diamine and p-tolylene diamine. These and other suitable polyamines described in detail in U.S. Pat. No. 4,046,729 at column 6, line 61 to column 7, line 26, which is incorporated herein by reference.

After the hiding coating composition is applied onto at least a portion of the primer-surfacer coating composition, a color-imparting non-hiding coating composition is applied onto at least a portion of the hiding coating composition using techniques that are known in the art.

It should be noted that the color-imparting non-hiding coating composition is applied onto a substantially uncured hiding coating composition. In other words, the hiding coating composition is not cured prior to application of the color-imparting non-hiding coating composition onto the hiding coating composition. However, in some embodiments, the color-imparting non-hiding coating composition is applied onto the hiding coating composition after a specified duration of time. In other words, after application of the hiding coating composition onto the substrate, a certain amount of time may pass prior to depositing the color-imparting non-hiding coating composition onto the uncured hiding coating composition. In some embodiments, the duration of time that can pass between the application of the hiding coating composition onto the substrate and the application of the color-imparting non-hiding coating composition can be ≧30 seconds. In other embodiments, the duration of time can be ≦20 minutes. In certain embodiments, the duration of time can range between any combination of values, which were recited in the preceding sentences, inclusive of the recited values. For example, the duration of time can range between 1 minute and 4 minutes.

It will be understood that the layer which results from the color-imparting non-hiding coating composition is substantially transparent. As used herein, “transparent” means having a BYK Haze index of less than 50 as measured using a BYK/Haze Gloss instrument. In some embodiments, the thickness of the resulting layer is ≧5 μm depending on the desired color effect. In other embodiments, the thickness of the resulting layer is ≦50 μm. In certain embodiments, the thickness of the resulting layer can range between any combination of values, which are recited in the preceding sentences, inclusive of the recited values. For example, in some embodiments, the thickness of the resulting layer is ≦10 μm in order to resist color variation that can occur due to process control limitations during coating application.

The polymer that is be incorporated into the color-imparting non-hiding coating composition can be the same polymer or different a different polymer from the polymer that is incorporated into the hiding coating composition. For example, in some embodiments, a polyester polymer can be used in both the color-imparting non-hiding coating composition as well as the hiding coating composition. In other embodiments, an acrylic polymer can be used in the hiding coating composition while a polyester polymer is used in the color-imparting non-hiding coating composition. Moreover, the curing agent that is incorporated into the color-imparting non-hiding coating composition can be the same or different from the curing agent that is incorporated into the hiding coating composition. For example, in some embodiments, both the hiding coating composition and the color-imparting non-hiding coating composition can both utilize an isocyanate curing agent. In other embodiments, the curing agent that is incorporated into the hiding coating composition can be an isocyanate while the curing agent that is incorporated into the color-imparting non-hiding coating composition can be an aminoplast.

In some embodiments, the color-imparting non-hiding coating composition can comprise the nanoparticulates, pigments, and/or ingredients that are described above. It will be understood that in some embodiments, the layer that results from the color-imparting non-hiding coating composition is a substantially transparent layer that comprise a nanoparticulate. It should be noted that the nanoparticulates, pigments, and/or ingredients that are incorporated into the color-imparting non-hiding coating composition may be the same or different from the nanoparticulates and/or pigments that are incorporated in the hiding coating composition.

In some embodiments, after the color-imparting non-hiding coating composition has been applied onto the hiding coating composition, the substrate is subjected to conditions sufficient to dehydrate at least a portion of the color-imparting non-hiding coating composition and the hiding coating composition. As a nonlimiting example, the substrate could be exposed to a temperature ranging from 66° C. (150° F.) to 82° C. (180° F.) for a time ranging from 1 minutes to 5 minutes in order to dehydrate the color-imparting non-hiding coating composition and/or the hiding coating composition. It should be noted, however, that this dehydration step is typically utilized when the non-hiding coating composition and/or the hiding coating composition is a waterborne coating composition.

In certain embodiments, after the color-imparting non-hiding coating composition has been applied onto the hiding coating composition, the process further comprises subjecting the coated substrate to conditions sufficient to cure the hiding coating composition as well as the color-imparting non-hiding coating composition. In other words, the hiding coating composition and the color-imparting non-hiding coating composition are cured simultaneously to form their respective coating layers. In some embodiments, the curing step occurs after the dehydration step that was described in the preceding paragraph.

Curing of the hiding coating composition and the color-imparting non-hiding coating composition can be accomplished by any known curing methods known in the art. For example, suitable curing methods include thermal energy, infrared, ionizing or actinic radiation, or by any combination thereof. In some embodiments, the curing operation is carried out at temperatures 210° C. (50° F.). In other embodiments, the curing operation is carried out at temperature ≦246° C. (475° F.). In certain embodiments, the curing operation is carried out at temperatures ranging between any combination of values, which were recited in the preceding sentences, inclusive of the recited values.

In certain embodiments, a topcoat coating composition is applied onto at least a portion of the uncured color-imparting non-hiding coating composition prior to the coated substrate being subjected to the curing operation. It will be understood that the topcoat coating composition may be applied onto the uncured color-imparting non-hiding coating composition using techniques that are known in the art, such as those described above. In some embodiments, the topcoat coating composition is a substantially non-pigmented coating composition which forms a substantially transparent coating, such as a clearcoat, upon curing. In these particular embodiments, the topcoat coating composition is sufficiently free of pigment and/or particles such that the optical properties of the resultant coatings are not seriously compromised.

In certain embodiments, however, the topcoat coating composition can comprise the nanoparticulates, pigments, and/or ingredients that are described above. It will be understood that in some embodiments, the layer that results from the topcoat coating composition is a transparent layer that comprises a nanoparticulate. It should be noted that the nanoparticulates and/or pigments that are incorporated into the topcoat coating composition may be the same or different from the nanoparticulates and/or pigments that are incorporated in the hiding coating composition and the color-imparting non-hiding coating composition.

In some embodiments, the topcoat coating composition is deposited onto the color-imparting non-hiding coating composition after a specified duration of time. In other words, after application of the color-imparting non-hiding coating composition onto the substrate, a certain amount of time may pass prior to depositing the substantially non-pigmented coating composition onto the uncured color-imparting non-hiding coating composition. In some embodiments, the duration of time that can pass between the application of the color-imparting non-hiding coating composition and the application of the substantially non-pigmented coating composition can be ≧30 seconds. In other embodiments, the duration of time can be ≦20 minutes. In certain embodiments, the duration of time can range between any combination of values, which were recited in the preceding sentences, inclusive of the recited values. For example, the duration of time can range between 1 minute and 5 minutes.

After the topcoat coating composition is deposited onto at least a portion of the uncured color-imparting non-hiding coating composition, the coated substrate is then subjected to the curing operation in order to cure the hiding coating composition, the color-imparting non-hiding coating composition, and the topcoat coating composition. In other words, all three coating compositions are simultaneously cured.

Suitable topcoat coating compositions can include aqueous coating compositions, solvent-based compositions, and compositions in solid particulate form (i.e., powder coating compositions). For example, the clear coating compositions comprising acrylic/melamines and/or those described in U.S. Pat. Nos. 4,650,718; 5,814,410; 5,891,981; and WO 98/14379, each of which are incorporated herein by reference, can be utilized in the present invention. Moreover, other examples of topcoat coating compositions that may be used include TKU-1050AR, ODCT8000, and those available under the tradenames DIAMOND COAT and NCT, all commercially available from PPG Industries, Inc.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

### Paint 1

Standard waterborne basecoat paint was made with the following ingredients using a conventional pigment dispersion:

| | |
|---|---|
| 3000.0 g | HWB6000 available from PPG Industries |
| 39.000 g | TSB 2180A ALUMINUM PASTE from TOYAL |
| | AMERICA |
| 174.000 g | TUFFLAKE 2222-AR from SILBERLINE MFG |
| 439.000 g | R179 conventional pigment dispersion produced by PPG |
| 30.000 g | XIRALLIC SW ND-71 RADIANT RED from MERCK |
| | JAPAN |
| 87.000 g | Solution of LUBRIZOL 2062 from LUBRIZOL CORP |

These ingredients were first blended with a blade agitator for 30 minutes. The sample was then reduced to 28 seconds #4 Ford viscosity cup.

### Paint 2

A silver waterborne basecoat was made with the following ingredients using aluminum flake only:

| | |
|---|---|
| 5.89 g | Hexyl cellosolve |
| 0.94 g | ALPATE 7670 NS from Toyal Europe |
| 3.83 g | TUFFLAKE 2222-AR from SILBERLINE MFG |
| 0.05 g | Dimethyl ethanolamine |
| 1.05 g | Antigassing Agent |
| 2.78 g | RESIMENE HM-2608 from CYTEC SURFACE |
| | SPECIALTIES |
| 40.94 g | de-ionized water |
| 6.41 g | Water compatible polyester |
| 0.55 g | Dimethylethanolamine, 50% solution |
| 10.71 g | Waterbase acrylic latex |
| 9.96 g | SETAQUA 6802 from NUPLEX RESINS LLC |
| 0.07 g | BYK-348 from BYK CHEMIE |
| 0.37 g | BYK-032 from BYK CHEMIE |
| 0.52 g | SURFYNOL 104E from AIR PRODUCTS & |
| | CHEMICALS INC |
| 0.91 g | 1-Octanol |
| 0.76 g | SBP 140/165 from Shell Chemicals |
| 0.76 g | SHELLSOL D70 from Shell Chemicals |
| 0.29 g | LAPONITE RD from SOUTHERN CLAY PRODUCTS |
| 0.91 g | ACRYSOL ASE-60 from ROHM & HAAS POLYMERS |
| | & RESINS |
| 0.22 g | water compatible PHOSPHATIZED EPOXY |
| 1.03 g | 2-Butoxyethanol |
| 0.92 g | 2-Ethylhexanol |

These ingredients were first blended with a blade agitator for 30 minutes. The sample was then reduced to 50 seconds #4 Ford viscosity cup.

### Paint 3:

Waterborne basecoat paint was made with the following ingredients using a waterborne nano pigment dispersion:

| | |
|---|---|
| 44.74 g | Water reducible polyurethane dispersion acrylic |
| 23.67 g | de-ionized water |
| 1.97 g | CYMEL 327 from Cytec Industries |
| 3.70 g | DOWANOL PnB |
| 2.80 g | 2-Butoxyethanol |
| 0.31 g | SYNALOX 100-D45 from Dow Chemical |
| 0.31 g | TINUVIN 1130 from CIBA ADDITIVES |
| 0.14 g | BYK-348 from BYK CHEMIE |
| 0.39 g | BYK-032 from BYK CHEMIE |
| 0.70 g | XIRALLIC SW ND-71 RADIANT RED from MERCK |
| | JAPAN |
| 0.49 g | Dimethylethanolamine, 50% solution |
| 0.42 g | LAPONITE RD from SOUTHERN CLAY PRODUCTS |
| 1.87 g | ACRYSOL ASE-60 from ROHM & HAAS POLYMERS |
| | & RESINS |
| 17.69 g | R179 waterborne nano pigment dispersion produced by PPG |

These ingredients were first blended with a blade agitator for 30 minutes. The sample was then reduced to 50 seconds #4 Ford viscosity cup.

### Paint 4:

Solventborne basecoat paint was made with the following ingredients using solventborne nano pigment dispersions:

| | |
|---|---|
| 480.865 g | N-Pentyl Propionate |
| 1308.109 g | Pattern Control Additive |
| 2524.355 g | RESIMENE CE-6528 from INEOS MELAMINES |
| 639.601 g | Solventborne polyester resin |
| 1282.877 g | Solventborne acrylic resin |
| 575.666 g | N-Butyl alcohol |
| 143.794 g | NEUTRALIZED DDBSA-IPA BLEND |
| 480.865 g | N-Pentyl Propionate |
| 1079.190 g | Solventborne anti-settling agent |
| 214.834 g | RESIMENE MR-231 from INEOS MELAMINES |
| 61.73 g | DDBSA-IPA BLEND from CHEMCENTRAL |
| 821.62 g | 850-9429 POLYESTER RESIN from HEXION |
| | SPECIALTY CHEMICALS |
| 1188.07 g | TCR 3010 ALUMINUM PASTE from TOYAL AMERICA |
| 546.51 g | PB60 solventborne nano pigment dispersion produced by |
| | PPG |
| 712.84 g | Black solventborne nano pigment dispersion produced by |
| | PPG |

These ingredients were first blended with a blade agitator for 30 minutes. Sample was reduced to 21″ seconds #4 Ford viscosity cup.

### Paint 5:

Solventborne basecoat paint was made with the following ingredients using solventborne nano pigment dispersions:

| | |
|---|---|
| 318.551 g | N-Pentyl propionate |
| 1138.596 g | Pattern Control Additive |
| 2197.235 g | RESIMENE CE-6528 from INEOS MELAMINES |
| 556.718 g | Solventborne polyester resin |
| 614.000 g | Solventborne acrylic resin |
| 501.068 g | N-Butyl alcohol |
| 125.160 g | NEUTRALIZED DDBSA-IPA BLEND |
| 418.551 g | N-Pentyl propionate |
| 626.228 g | Solventborne anti-settling agent |
| 186.994 g | RESIMENE MR-231 from INEOS MELAMINES |
| 53.732 g | DDBSA-IPA BLEND from CHEMCENTRAL |
| 278.000 g | 850-9429 POLYESTER RESIN from HEXION |
| | SPECIALTY CHEMICALS |
| 4070.162 g | R179 solventborne nano pigment dispersion produced by |
| | PPG |
| 104.265 g | PB60 solventborne nano pigment dispersion produced by |
| | PPG |
| 173.988 g | Black solventborne nano pigment dispersion produced by |
| | PPG |

These ingredients were first blended with a blade agitator for 30 minutes. Sample was reduced to 17″ seconds #4 Ford viscosity cup.

### Clear 1:

Solventborne Clearcoat commercially available from PPG under the product code NDCT5002. Sample was reduced to 35 seconds #4 Ford viscosity cup.

### Clear 2:

Solventborne Clearcoat commercially available from PPG under the product code NDCT5002 and tinted as described below:

| | |
|---|---|
| 100 g | Clear 1 (NDCT5002) |
| 1.09 g | R179 solventborne nano pigment dispersion produced by PPG |

These ingredients were first blended with a blade agitator for 30 minutes. Sample was reduced to 35 seconds #4 Ford viscosity cup.

### Process Examples

The following examples (1) through (6) were applied over test substrate was 4″×12″ ACT CRS panels electrocoated with ED6060, a cationically electrodepositable primer commercially available from PPG. These panels are available from ACT Laboratories of Hillsdale, Mich. The test substrates were then spray applied (2 coats automated spray with 60 second ambient flash between coats) to give a dry film thickness of 30 to 40 microns with liquid primer surfacer. The primed test substrates were cured 30 minutes at 302° F. The following examples were then applied to the aforementioned primed test substrates.

### Process Example 1

This example represents the current or standard condition against which examples (2) to (6) are compared:

PAINT 1 is applied to a dried film of 12 to 18 microns using a rotary or air atomized applicator in two coats. The PAINT 1 is then ambient air flashed for minimum of 30 seconds followed by a dehydration flash of 3 minutes at 180° F. up to 15 minutes at 250° F. CLEAR 1 is then applied at 35 to 48 microns using a rotary or air atomized applicator in two coats. The combined coatings are then cured for 30 minutes at 285° F.

The (1) process is shown to have limited color capability with optimal process control capability.

### Process Example 2

PAINT 1 is applied to a dried film of 8 to 10 microns using a rotary or air atomized applicator in one coat. The PAINT 1 coating is then ambient air flashed for minimum of 90 seconds followed by the application of PAINT 2. PAINT 2 is applied to a dried film of 5 to 7.5 microns using a rotary or air atomized applicator in one coat. The combined PAINT 1 and PAINT 2 coatings are then ambient air flashed for minimum of 30 seconds followed by a dehydration flash of 3 minutes at 180° F. up to 15 minutes at 250° F. CLEAR 1 is then applied at 35 to 48 microns using a rotary or air atomized applicator two (2) coats. The combined coatings are then cured for 30 minutes at 285° F.

The (2) process is shown to have improved color capability with acceptable but with room for improvement in process control capability.

### Process Example 3

PAINT 1 is applied to a dried film of 12 to 18 microns using a rotary or air atomized applicator in two coats. The PAINT 1 coating is then ambient air flashed for minimum of 30 seconds followed by a dehydration flash of 3 minutes at 180° F. up to 15 minutes at 250° F. CLEAR 2 is then applied at 35 to 48 microns using a rotary or air atomized applicator in two coats. The combined coatings are then cured for 30 minutes at 285° F.

The (3) process is shown to have improved color capability with improved process control capability over process (2).

### Process Example 4

PAINT 2 is applied to a dried film of 10 to 12 microns using a rotary or air atomized applicator in one coat. The PAINT 1 coating is then ambient air flashed for minimum of 90 seconds followed by the application of PAINT 2. PAINT 2 is applied to a dried film of 10 to 12 microns using a rotary or air atomized applicator in one coat. The combined PAINT 1 and PAINT 2 coatings are then ambient air flashed for minimum of 30 seconds followed by a dehydration flash of 3 minutes at 180° F. up to 15 minutes at 250° F. CLEAR 1 is then applied at 35 to 48 microns using a rotary or air atomized applicator in two (2) coats. The combined coatings are then cured for 30 minutes at 285° F.

The (4) process is shown to have improved color capability acceptable and acceptable but with room for improvement in process control capability.

### Process Example 5

PAINT 1 is applied to a dried film of 8 to 10 microns using a rotary or air atomized applicator in one coat. The PAINT 1 coating is then ambient air flashed for minimum of 90 seconds followed by the application of PAINT 2. PAINT 2 is applied to a dried film of 5 to 7.5 microns using a rotary or air atomized applicator in one coat. The combined PAINT 1 and PAINT 2 coatings are then ambient air flashed for minimum of 30 seconds followed by a dehydration flash of 3 minutes at 180° F. up to 15 minutes at 250° F. CLEAR 2 is then applied at 35 to 48 microns using a rotary or air atomized applicator in two (2) coats. The combined coatings are then cured for 30 minutes at 285° F.

The (5) process is shown to have optimal color capability with improved process control capability over process (2).

### Process Example 6

PAINT 4 is applied to a dried film of 10 to 17 microns using a rotary or air atomized applicator in one coat. The PAINT 4 coating is then ambient air flashed for 90 seconds to 5 minutes followed by the application of PAINT 5. PAINT 5 is applied to a dried film of 15 to 25 microns using a rotary or air atomized applicator in one coat. The combined PAINT 4 and PAINT 5 coatings are then ambient air flashed for 5 to 10 minutes. CLEAR 1 is then applied at 40 to 50 microns using a rotary or air atomized applicator in two (2) coats. The combined coatings are then cured for 30 minutes at 285° F.

The (6) process is shown to have improved color capability acceptable and acceptable but with room for improvement in process control capability. The (6) process is solventborne coating example of (4) process.

What is claimed is:

1. A method of coating a substrate comprising:
(a) depositing a primer-surfacer coating composition onto at least a portion of said substrate;
(b) curing at least a portion of said primer-surfacer coating composition;
(c) depositing a hiding coating composition onto a least a portion of said primer-surfacer coating composition;
(d) depositing a color-imparting non-hiding coating composition onto at least a portion of said hiding coating composition, wherein said color-imparting non-hiding coating composition comprises a nanoparticulate, and wherein a portion of said hiding coating composition is not cured prior to the deposition of said color-imparting non-hiding coating composition;
(e) optionally, dehydrating at least a portion of said hiding coating composition and said color-imparting non-hiding coating composition; and
(f) curing at least a portion of said hiding coating composition and said color-imparting non-hiding coating composition simultaneously.

2. The method of claim 1, further comprising applying a topcoat coating composition onto at least a portion of said color-imparting non-hiding coating composition prior to step (f), and wherein at least a portion of said color-imparting non-hiding coating composition is not cured prior to the deposition of said topcoat coating composition, and wherein step (f) further comprises curing at least a portion of said topcoat coating composition.

3. The method of claim 2, wherein said topcoat coating composition comprises a nanoparticulate, and wherein said another nanoparticulate may be the same or different from said nanoparticulate.

4. The method of claim 3, wherein said another nanoparticulate is an encapsulated nanoparticulate.

5. The method of claim 1, wherein said hiding coating composition comprises a metallic and/or an effect pigment.

6. The method of claim 1, wherein said hiding coating composition comprises a nanoparticulate.

7. The method of claim 1, wherein said hiding coating composition comprises a pigment.

8. The method of claim 1, wherein said color-imparting non-hiding coating composition comprises another nanoparticulate, and wherein said another nanoparticulate may be the same or different from said nanoparticulate.

9. The method of claim 8, wherein said another nanoparticulate is an encapsulated nanoparticulate.

10. The method of claim 1, wherein said color-imparting non-hiding coating composition comprises another nanoparticulate and said topcoat coating composition comprises yet another nanoparticulate, and wherein one or more of said nanoparticulate, said another nanoparticulate, and said yet another nanoparticulate may be the same or different.

11. The method of claim 1, wherein said nanoparticulate is an encapsulated nanoparticulate.

12. A method of coating a substrate comprising:
(a) depositing a primer-surfacer coating composition onto at least a portion of said substrate;
(b) curing at least a portion of said primer-surfacer coating composition;
(c) depositing a hiding coating composition onto a least a portion of said primer-surfacer coating composition;
(d) depositing a color-imparting non-hiding coating composition onto at least a portion of said hiding coating composition, wherein said color-imparting non-hiding coating composition comprises a nanoparticulate, and wherein a portion of said hiding coating composition is not cured prior to the deposition of said color-imparting non-hiding coating composition;
(e) optionally, dehydrating at least a portion of said hiding coating composition and said color-imparting non-hiding coating composition;
(f) applying a topcoat coating composition onto at least a portion of said color-imparting non-hiding coating composition; and
(g) curing at least a portion of said hiding coating composition, said color-imparting non-hiding coating composition, said color-imparting non-hiding coating composition, and said topcoat coating composition simultaneously.

13. The method according to claim 12, wherein said hiding coating composition comprises another nanoparticulate, and wherein said another nanoparticulate may be the same or different from said nanoparticulate.

14. The method according to claim 12, wherein said topcoat coating composition comprises another nanoparticulate, and wherein said another nanoparticulate may be the same or different from said nanoparticulate.

15. The method according to claim 12, wherein said hiding coating composition comprises another nanoparticulate, and said topcoat coating composition comprises yet another nanoparticulate, and wherein one or more of said nanoparticulate, said another nanoparticulate, and said yet another nanoparticulate may be the same or different.

16. The method according to claim 12, wherein said nanoparticulate is an encapsulated nanoparticulate.

17. The method according to claim 12, wherein said hiding coating composition comprises a metallic and/or an effect pigment.

18. The method according to claim 12, wherein said hiding coating composition comprises a pigment.
